(19) United States
(12) Patent Application Publication
(10) Pub. No.: US 2017/0372250 A1
(43) Pub. Date: Dec. 28, 2017

(54) SYSTEM AND METHOD FOR ANALYZING TIMESHEET DATA

(71) Applicant: HCL Technologies Limited, Noida (IN)

(72) Inventors: Satya Sai Prakash KANAKADANDI, Hyderabad (IN); S U M Prasad DHANYAMRAJU, Hyderabad (IN)

(21) Appl. No.: 15/615,764

(22) Filed: Jun. 6, 2017

(30) Foreign Application Priority Data
Jun. 28, 2016 (IN) 201611022111

(51) Int. Cl. G06Q 10/06; G06Q 40/00; G06F 17/30; G06Q 10/10

(52) U.S. Cl. CPC G06Q 10/06393; G06Q 10/1097; G06Q 40/125; G06F 17/3053

(57) ABSTRACT

System and method for analyzing timesheet data to derive serendipitous insights are disclosed. Timesheet data for a plurality of employees working on multiple projects may be stored. The timesheet data may be analyzed to generate project insights associated with project tasks, for each of the plurality of employees. Priority scores for each of the project tasks may be calculated based on the project insights. Further, a dependency factor of the project task with respect to an outcome of the project may be evaluated.

### CROSS REFERENCE TO RELATED APPLICATIONS AND PRIORITY

The present application claims priority from Indian Patent Application No. 201611022111 filed on 28 Jun. 2016, the entirety of which is hereby incorporated by reference.

### TECHNICAL FIELD

The present disclosure in general relates to the field of project management. More particularly, the present disclosure relates to a system and method for identifying serendipitous insights in project management.

### BACKGROUND

The wide deployment of projects in organizations today makes the search for factors that influence project success of great importance to researchers and practitioners. The fact that majority of projects fail on at least one measure of success, and that millions of dollars in the industry reported each year as waste, suggests that there is a critical need for improving the way these projects are managed. Typically, projects start with a planning phase and move into an execution stage. In the planning phase a project is broken down into multiple logical chunks of project tasks. These project tasks are granular and independent in nature. For executing these project tasks a subset of resources available in the overall pool of resources may be allocated. Depending on the way these project tasks are to be executed, resources may be allocated to these project tasks and progress may be tracked.

Timesheet data is an important instrument used, for example, in software project management for tracking project activities. Numerous computer applications are available for tracking details of an employee's activities. These activities can include projects that the employee works on and the amount of time spent on each project. Employees may fill out timesheets periodically (e.g. daily, weekly or monthly), to report the effort spent on different project tasks undertaken during the time period.

In a typical project, timesheet data may be used to determine the cost of the project by identifying the resources (employees) allocated to the project, the effort expended by them and the cost of the resources. Data available in the timesheets is thus an important source of historical development effort.

### SUMMARY

This summary is provided to introduce aspects related to system and method for an alert or notification system based on diagnostic analytics, further described below in the detailed description. This summary is not intended to identify essential features of the claimed subject matter nor is it intended for use in determining or limiting the scope of the claimed subject matter.

In one implementation, a system for analyzing timesheet data is disclosed. The system includes a memory and a processor coupled to the memory. The processor may be configured to execute instructions stored in the memory to store timesheet data for a plurality of employees assigned to a project. The processor may be further configured to analyze the stored timesheet data to determine, for at least one employee, at least one project task being performed. The processor may further execute instructions stored in the memory to identify, at least one project insight for the at least one employee, wherein the project insight comprising at least a time billed against the at least one project task and a total time billed for the project. The processor may be further configured to execute instructions stored in the memory to generate, based on the at least one project insight, a priority score for the at least one project task. Further, the processor is configured to execute instructions stored in the memory to evaluate, based on the priority score, a dependency factor of the at least one project task on an outcome of the project.

In another implementation, a method for analyzing timesheet data is disclosed. The method includes storing timesheet data for a plurality of employees assigned to a project. The method further includes analyzing the stored timesheet data to determine, for at least one employee, at least one project task being performed. The method further includes identifying, at least one project insight for the at least one employee, wherein the project insight comprising at least a time billed against the at least one project task and a total time billed for the project. Further, the method includes generating, based on the at least one project insight, a priority score for the at least one project task. Further, the method includes evaluating, based on the priority score, a dependency factor of the at least one project task on an outcome of the project.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system for analyzing timesheet data, in accordance with an embodiment of the present subject matter.

FIG. 2 illustrates detailed workings of the system, in according with an embodiment of the present subject matter.

FIG. 3 illustrates a method for analyzing timesheet data, in accordance with an embodiment of the present subject matter.

### DETAILED DESCRIPTION

The present systems and methods will now be described more fully hereinafter with reference to the accompanying drawings in which exemplary embodiments of the disclosure are shown. However, the disclosure may be embodied in many different forms and should not be construed as limited to the representative embodiments set forth herein. The exemplary embodiments are provided so that this disclosure will be both thorough and complete, and will fully convey the scope of the disclosure and enable one of ordinary skill in the art to make, use and practice the disclosure. Like reference numbers refer to like elements throughout the various drawings.

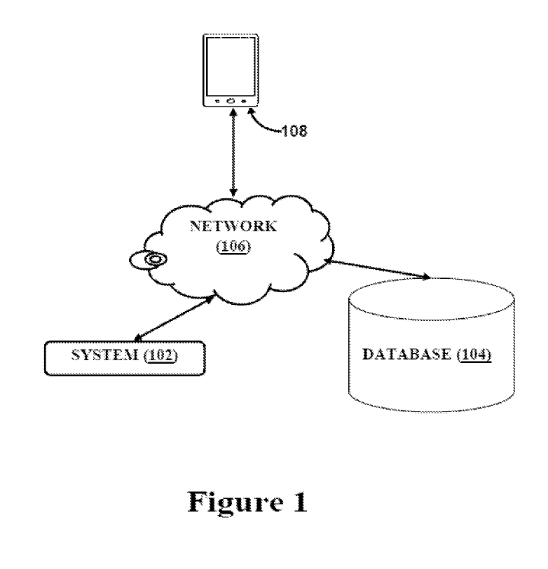

Referring to FIG. 1, a network implementation 100 of a system 102 for analyzing timesheet data for an employee is disclosed. In an embodiment, the system 102 may store timesheet data for a plurality of employees assigned to a project, in an organization. In the embodiment, the system 102 may pull timesheet data for the plurality of employees, for example, from a central database 104. In an implementation, the central database may be a database storing data associated with the organization such as timesheets, reporting structures, departmental information, employee details, leave details and the like. In a specific example, the central database 104 may store project data for a project such as number of resources deployed, types of project tasks created, project schedule, project budgets and the like. In one implementation, the system 102 may also pull relevant project data from the central database 104 along with the timesheet data. In an example, the system 102 may receive the timesheet data and other project data from the central database 104 over network 106.

In general, the network 106 may be a wireless network, a wired network or a combination thereof. The network 106 can be implemented as one of the different types of networks, such as intranet, local area network (LAN), wide area network (WAN), the internet, and the like. The network 106 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 may include a variety of network devices, including routers, bridges, servers, computing devices, storage devices, and the like.

In an embodiment, the system 102 may analyze the timesheet data for an employee for identifying one or more insights effecting an outcome—i.e. success or failure—of a project that the employee has been assigned to. In an exemplary implementation, the identification of the one or more insights from the timesheet data may be serendipitous in nature. That is, in typical project execution, these insights may be overlooked even though these insights may have a considerable effect on the outcome of the project. However, using capabilities of the system 102, as would be described in subsequent text, these insights may be identified and their effect on the outcome of the project may be successfully evaluated. For example, for a particular employee referring to “stack overflow” website may help him/her fix bugs quickly as compared to his/her own knowledge. Further, his/her peers facing similar bug issues may also take more time without referring to the website. In another example, an employee spending half hour end of each day to log brief notes and comments on day's work may help him/her cross refer and improve overall productivity. In yet another example, teams spending more time in code reviews may be leading to deadline slippage.

In another embodiment, a similarity score for two or more employees performing a similar project task may also be determined by the system 102. In the embodiment, project insights for a plurality of employees working on the project task may be identified. Based on the project insights, priority scores for the project task being performed by multiple employees may be computed. A similarity score may then be generated for two or more employees based on similar priority scores of these employees for the project task. In an implementation, the similarity score may be utilized to investigate interrelationships between two or more employees based on similar priority scores. This may in turn, facilitate, for example, accurate replacement of a first employee with a second employee, when the first employee leaves the organization or is assigned to a different project.

In an implementation, the system 102 may analyze the timesheet data by one of multiple regression analysis, analysis of variance (ANOVA), discriminant analysis or support vector machine (SVM) analysis. In the implementation, the project tasks identified from the timesheet data may be analyzed and one or more insights for the project tasks may be identified. The one or more insights associated with a project task performed by an employee, in a non-limiting example, may include time billed against the project task and a total time billed for the project. Based on the one or more insights, priority score for the project task may be evaluated. The priority score, in an embodiment, may be utilized to evaluate a dependency factor of the project task on an outcome of the project. In an embodiment, the priority scores as well as the respective dependency factors may be communicated to a user device 108. In an example, the user device 108 may be a device belonging to a team lead, a project manager, a head of department, and the like.

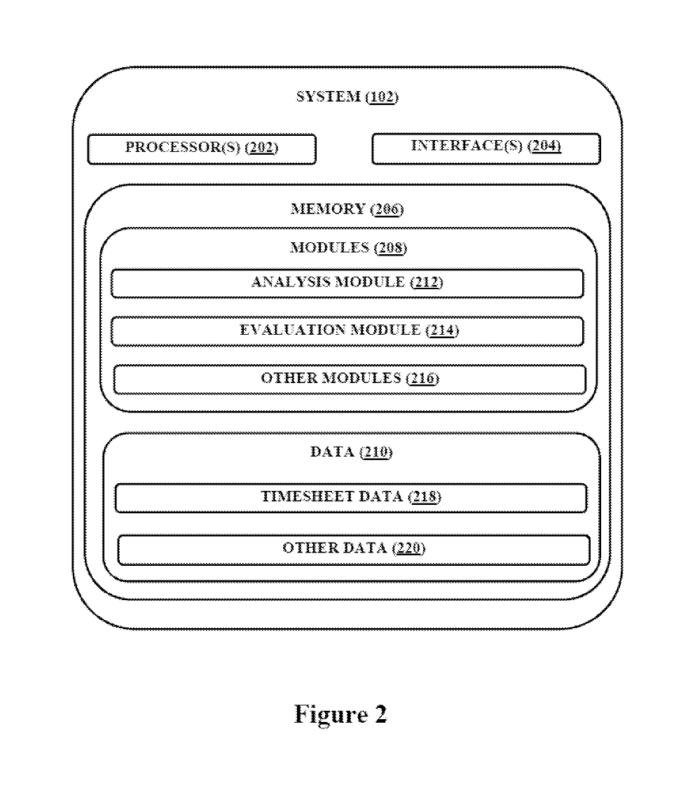

FIG. 2 illustrates the system 102 in detail, in accordance with an embodiment of the present disclosure. In one embodiment, the system 102 may include at least one processor 202, an input/output (I/O) interface 204, and a memory 206. The at least one processor 202 may be implemented as one or more microprocessors, microcomputers, microcontrollers, digital signal processors, central processing units, state machines, logic circuitries, and/or any devices that manipulate signals based on operational instructions. Among other capabilities, the at least one processor 202 is configured to fetch and execute computer-readable instructions or modules stored in the memory 206.

The I/O interface 204 may include a variety of software and hardware interfaces, for example, a web interface, a graphical user interface, and the like. The I/O interface 204 may enable the system 102 to communicate with other computing devices, such as web servers and external data servers (not shown). The I/O interface 204 can facilitate multiple communications within a wide variety of networks and protocol types, including wired networks, for example, LAN, cable, etc., and wireless networks, such as WLAN, cellular, or satellite. The I/O interface 204 may include one or more ports for connecting a number of devices to one another or to another server.

The memory 206 may include any computer-readable medium or computer program product known in the art including, for example, volatile memory, such as static random access memory (SRAM) and dynamic random access memory (DRAM), and/or nonvolatile memory, such as read only memory (ROM), erasable programmable ROM, flash memories, hard disks, optical disks, a compact disks (CDs), digital versatile disc or digital video disc (DVDs) and magnetic tapes. The memory 206 may include modules 208 and data 210.

The modules 208 include routines, programs, objects, components, data structures, etc., which perform particular tasks or implement particular abstract data types. In one implementation, the modules 208 may include an analysis module 212, an evaluation module 214, and other modules 216. The other modules 216 may include programs or coded instructions that supplement applications and functions of the system 102.

The data 210, amongst other things, serves as a repository for storing data processed, received, and generated by one or more of the modules 208. The data 210 may also include timesheet data 218 and other data 220. Each of the aforementioned modules is explained in detail in subsequent paragraphs of the specification.

In operation, the system 102 may store timesheet data for a plurality of employees working in an organization. In an implementation, the system 102 may analyze the timesheet data in order to generate one or more insights for a plurality of project tasks being performed by multiple employees of the organization. Based on the one or more insights, priority scores for the plurality of project tasks may be generated and evaluated in order to determine effects of each of the plurality project tasks on an outcome of the project.

In an implementation, the analysis module 212 may receive timesheet data for the plurality of employees from the central database 104. As described in the foregoing, the central database 104 may be a data store having data such as timesheet data, organizational information, project information, reporting structures, and the like. In an example, the timesheet data may be stored in the system 102 as the timesheet data 218.

In an embodiment, the analysis module 212 may analyze the timesheet data to identify one or more project tasks being performed by an employee. In an example, the one or more project tasks may belong to a single project or to multiple projects to which the employee is assigned to. In another example, multiple employees may be assigned to a single project and perform the same project tasks. In an implementation, the timesheet data may be analyzed by the analysis module 212 in order to identify one or more insights, associated with the project tasks, for the employee. These one or more insights may include time billed against the project tasks and time billed for the entire project. Based on these insights, priority scores for each of the project tasks may be determined. Further, outcome (success or failure) of the project may also be taken into account so as to determine a dependency factor of the project tasks on the outcome. In an implementation, the dependency factor may be determined by the evaluation module 214. Sample timesheet data for analysis is as shown below in Table 1:

TABLE 1

| EMP | Project | Success | Project Tasks | | | | | | |
|---|---|---|---|---|---|---|---|---|---|
| ID | Code | (Categorical) | Task 1 | Task 2 | Task 3 | Task 4 | . . . | . . . | Task n |
| Emp 1 | PC 123 | Y | H11 | H12 | H13 | H14 | . . . | . . . | H1n |
| Emp 2 | PC 123 | Y | H21 | H22 | H23 | H24 | . . . | . . . | H2n |
| Emp 2 | PC 456 | N | H21 | H22 | H23 | H24 | . . . | . . . | H2n |
| Emp 3 | PC 123 | Y | H31 | H32 | H33 | H34 | . . . | . . . | H3n |
| . . . | . . . | . . . | . . . | . . . | . . . | . . . | . . . | . . . | . . . |
| . . . | . . . | . . . | . . . | . . . | . . . | . . . | . . . | . . . | . . . |
| Emp m | PC 789 | Y | Hm1 | Hm2 | Hm3 | Hm4 | . . . | . . . | Hmn |

As depicted, time values for multiple employees, denoted by Emp 1−Emp m assigned to multiple projects, PC 123, PC 456 and PC 789, may be recorded in a typical timesheet. In an example, Emp 1 may be assigned to project PC 123 having different tasks as denoted by Task 1−Task n. Similarly, Emp 2 may be assigned to two different projects, namely PC 123 and PC 456. Time entries for multiple employees may be displayed likewise. Further success of the project may be listed in a categorical fashion (such as binary 0 for failure and 1 for success, or Y for success or N for failure). Hours billed by each employee on the different projects may be listed under respective project tasks. As shown, Emp 1 billed H11 hours on Task 1, H12 hours on Task 2 and so on. Similarly Emp 2 billed H11 on Task 1 of Project 123 and Project 456. Further, PC 123 was a successful project, however PC 456 encountered failure.

In an implementation, the analysis module 212 may select a particular project from multiple projects depicted in the timesheet data. Based on the selected project, entries specific to the project may then be filtered out for further analysis. The entries may include different project tasks, time billed against each project task, total hours billed on the project, and different employees assigned to the project. An exemplary timesheet entry for project PC 123 is as depicted below in Table 2:

| | | | Project Tasks | | | | Total Number of |
|---|---|---|---|---|---|---|---|
| | | | PoC | Information | General | | Hours spent by an |
| EMP | Project | Success | Studies | Collection | Meeting | Coding | Employee for project |
| ID | Code | (Categorical) | Task 2 | Task 3 | Task 5 | Task 7 | PC 123 |
| Emp 1 | PC 123 | Y | H12 | H13 | H15 | H17 | TotH-E1 |
| Emp 2 | PC 123 | Y | H22 | H23 | H25 | H27 | TotH-E2 |
| Emp 3 | PC 123 | Y | H32 | H33 | H35 | H37 | TotH-E3 |
| Emp 6 | PC 123 | Y | H62 | H63 | H65 | H67 | TotH-E6 |
| . . . | . . . | . . . | . . . | . . . | . . . | . . . | . . . |
| . . . | . . . | . . . | . . . | . . . | . . . | . . . | . . . |
| Emp 9 | PC 123 | Y | H92 | H93 | H95 | H97 | TotH-E9 |

| | | | | | |
|---|---|---|---|---|---|
| Total Hours Spent on | TotH- | TotH-T3 | TotH-T5 | TotH- | Total Hours Spent |
| Project PC 123 | T1 | | | T7 | on PC 123 |

As shown, timesheet data for a specific project, e.g. PC 123 may be filtered out by the analysis module 212. The timesheet data for PC 123 may include different project tasks of the project. Further, different insights for the project tasks such as time billed against each project task for one or more employees, e.g. Emp 1, Emp 2, Emp 6, and so on, may also be recorded. Also, insights such as total time for the project as well as for each task may be calculated by taking a sum of individual entries for each of the multiple employees.

In an implementation, the analysis module 214 may perform the timesheet data, by defining dependent and independent variables. In one example, project success may be categorized as dependent variable and may be described as a categorical binary variable like successful (1)/failed (0) or as continuous variable like CSAT Similarly, the project tasks performed by employees may be categorized as independent variables as mentioned in the timesheet and may be described as continuous variables like hours spent on a particular project task, or a binary variable like project task performed (1) or project task not performed (0).

Depending on the type of dependent variable i.e. continuous or categorical, various statistical methods may be applied for data analysis. For continuous dependent variable, model building methods like multiple regression, ANOVA may be used. Similarly, for categorical dependent variables, model building methods such as discriminant analysis, support vector machine (SVM) analysis may be used. Further, applying these statistical methods could serendipitously reveal some inconspicuous relationships between project tasks with the project outcome.

In one embodiment, the analysis module 212 may determine priority scores for each of the project tasks based on the one or more insights identified from the timesheet data. In an example, referring back to Table 2, priority scores may be calculated based on the project tasks as well as based on the employees. For example, the priority score for an employee Emp I for different tasks may be given as:

PEI2=HI2/TotH−EI

PEI3=HI3/TotH−EI

PEI5=HI5/TotH−EI

PEI7=HI7/TotH−EI

In the above calculations, HI2 denotes hours spent by the employee Emp I on task 2. Similarly, total time spent on the project by Emp I may be given by TotH−EI which may be calculated as TotH−EI=HI2+HI3+HI5+HI7.

Further, referring again to Table 2, priority scores may also be calculated based on the project tasks. For example, for each of the tasks, i.e., Task 2, Task 3, Task 5 and Task 7, priority scores may be calculated as follows:

For Task 2−PT2=TotH−T2/TotH−Tall

For Task 3−PT3=TotH−T3/TotH−Tall

For Task 5−PT5=TotH−T5/TotH−Tall

For Task 7−PT7=TotH−T7/TotH−Tall

In the above calculations, PT2, in an example, may denote priority of Task 2. Further TotH−T2 may denote sum of time billed against Task 2 by all the employees. Further TotH−Tall may denote total time billed for all the project tasks in the project and may be calculated as: TotH−Tall=TotH−T2+TotH−T3+TotH−T5+TotH−T7.

In an embodiment, based on the calculated priority scores, dependency factors of the project tasks on the outcome of the project may be evaluated by the evaluation module 214. In an exemplary implementation, the evaluation module 214 may utilize a supervised learning technique to evaluate project outcome as a function of project task priority scores. In an example, such an evaluation may be done based on a discriminant analysis method or a SVM analysis method. Evaluation of the project outcome as a function of project task priorities may in turn lead to identification of priority scores for the project tasks that are essential to project success or that are detrimental to the project success. The project task priority scores as a function of the project outcome may be as depicted in table 3:

TABLE 3

| | | Priorities of the Project Tasks | | | | | | |
|---|---|---|---|---|---|---|---|---|
| | | Project | | | Presentation | | | |
| | | Related | PoC | Information | Material | | | General |
| Project | Success | Meeting | Studies | Collection | Development | . . . | . . . | Meeting |
| Code | (Categorical) | Task 1 | Task 2 | Task 3 | Task 4 | . . . | . . . | Task n |
| PC 123 | Y | PT11 | PT12 | PT13 | PT14 | . . . | . . . | PT1n |
| PC 456 | N | PT21 | PT22 | PT23 | PT24 | . . . | . . . | PT2n |
| . . . | . . . | . . . | . . . | . . . | . . . | . . . | . . . | . . . |
| . . . | . . . | . . . | . . . | . . . | . . . | . . . | . . . | . . . |
| PC 789 | Y | PTm1 | PTm2 | PTm3 | PTm4 | . . . | . . . | PTmn |

As depicted, priority scores for each of the priority tasks may be listed for each project. Further, values of the priority scores for the project tasks may be evaluated to identify the dependency factor of that project task on the outcome of the project. For example, for a successful project, project tasks having high priority scores may have a positive dependency on the project outcome. Similarly, for a failed project, project tasks having high priority scores may have a negative dependency on the project outcome. These dependency factors for the different project tasks may be essential in planning for similar projects to be taken up in the future.

In another embodiment, the evaluation module 214 may perform independent analysis of project task priority scores for different employees in order to evaluate a similarity factor between two or more employees. In an example, the evaluation may be done using text clustering, or PCA. The evaluation of the similarity factor may be done as given below in Table 4:

| | | | Priorities of the Project Tasks | | | |
|---|---|---|---|---|---|---|
| | | | PoC | Information | General | |
| EMP | Project | Success | Studies | Collection | Meeting | Coding |
| ID | Code | (Categorical) | Task 2 | Task 3 | Task 5 | Task 7 |
| Emp 1 | PC 123 | Y | PE12 | PE13 | PE15 | PE17 |
| Emp 2 | PC 123 | Y | PE22 | PE23 | PE25 | PE27 |
| Emp 3 | PC 123 | Y | PE32 | PE33 | PE35 | PE37 |
| Emp 6 | PC 123 | Y | PE62 | PE63 | PE65 | PE67 |
| . . . | . . . | . . . | . . . | . . . | . . . | . . . |
| . . . | . . . | . . . | . . . | . . . | . . . | . . . |
| Emp 9 | PC 123 | Y | PE92 | PE93 | PE95 | PE97 |

As illustrated, priority score for each project task of each employee working on a project, e.g. PC 123, may be listed down. Each priority score for an employee may be compared to other employees for a given project task. Based on the comparison, for example, it may be evaluated that for a given successful project, who are the employees that work in a similar fashion. That is, two or more employees having a similar workflow or approach to the given project may be evaluated. Such an evaluation may be utilized when a need for switching employees in a project may arise. Further, in case a first employee leaves an organization while being assigned to a project, a second employee identified as similar to the first employee may be assigned to take up the first employee's role.

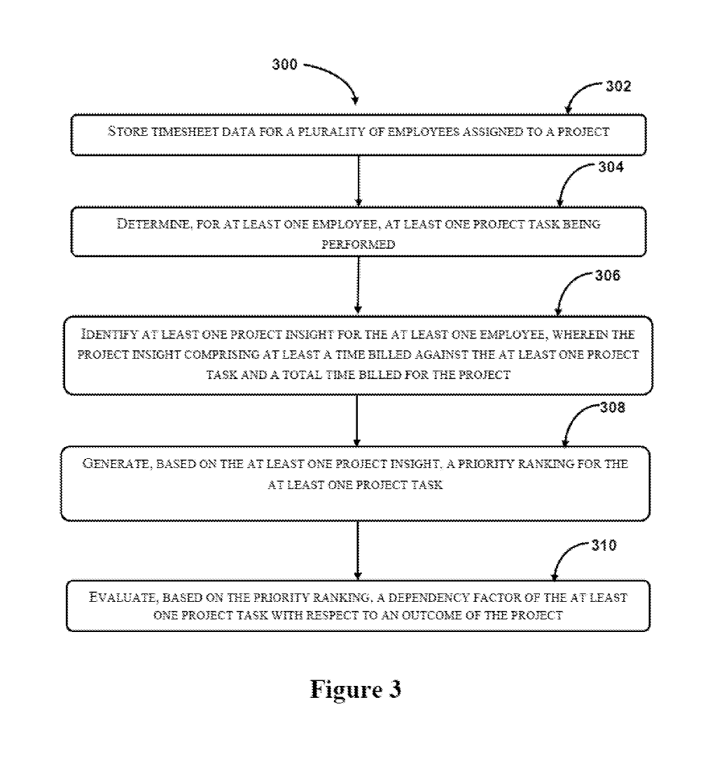

Referring now to FIG. 3, a method 300 for analyzing time sheet data is disclosed. The method may start at step 302 wherein timesheet data for a plurality of employees assigned to a project. In an implementation, the timesheet data may be received from a database central to an organization to which the plurality of employee belongs.

At step 304, the timesheet data may be analyzed to determine, for at least one employee, at least one project task being performed. Further, at step 306 the timesheet data may be further analyzed to identify at least one project insight for the at least one employee. The project insight, in one implementation, may include a time billed against the at least one project task and a total time billed for the project, by the at least one employee.

At step 306, a priority score for the at least project task may be generated based on the at least one project insight. In an example, the priority score based on the project insight may be determined based on analyzing the timesheet data using techniques such as multiple regression analysis, analysis of variance (ANOVA), discriminant analysis, or support vector machine (SVM) analysis.

At step 308, a dependency factor of the at least one project task, with respect to an outcome of the project may be evaluated.

Although implementations for methods and systems for enabling a maintenance activity of an equipment have been described in language specific to structural features and/or methods, it is to be understood that the appended claims are not necessarily limited to the specific features or methods described. Rather, the specific features and methods are disclosed as examples of implementations for generating real time network alerts based on analytics.

We claim:

1. A system comprising:
a memory; and
a processor coupled to the memory, wherein the processor is configured to execute instructions stored in the memory to:
store timesheet data for a plurality of employees assigned to a project;
analyze the stored timesheet data to:
determine, for at least one employee, at least one project task being performed; and
identify, at least one project insight for the at least one employee, wherein the project insight comprising at least a time billed against the at least one project task and a total time billed for the project;
generate, based on the at least one project insight, a priority score for the at least one project task; and
evaluate, based on the priority score, a dependency factor of the at least one project task on an outcome of the project.

2. The system of claim 1, wherein the processor is further configured to execute instructions stored in the memory to:
determine a project task being performed by the plurality of employees;
identify project insights for the plurality of employees, wherein the project insights at least comprising time billed against the project task by each of the plurality of employees and a total time billed for the project by each of the plurality of employees;
compute, based on the project insights, priority scores of the project task, for the plurality of employees; and
generate, based on the priority scores, a similarity score for two or more employees from the plurality of employees.

3. The system of claim 1, wherein the timesheet data is analyzed using one of multiple regression analysis, analysis of variance (ANOVA), discriminant analysis, and support vector machine (SVM) analysis.

4. The system of claim 1, wherein the outcome of the project comprises one of a success of the project and a failure of the project.

5. A method comprising:
storing timesheet data for a plurality of employees assigned to a project;
analyzing the stored timesheet data to:
determine, for at least one employee, at least one project task being performed; and
identify, at least one project insight for the at least one employee, wherein the project insight comprising at least a time billed against the at least one project task and a total time billed for the project;
generating, based on the at least one project insight, a priority score for the at least one project task; and
evaluating, based on the priority score, a dependency factor of the at least one project task on an outcome of the project.

6. The method of claim 6, further comprising:
determining a project task being performed by the plurality of employees;
identifying project insights for the plurality of employees, wherein the project insights at least comprising time billed against the project task by each of the plurality of employees and a total time billed for the project by each of the plurality of employees;
computing, based on the project insights, priority scores of the project task, for the plurality of employees; and
generating, based on the priority scores, a similarity score for two or more employees from the plurality of employees.

7. The method of claim 6, wherein the timesheet data is analyzed using one of multiple regression analysis, analysis of variance (ANOVA), discriminant analysis, and support vector machine (SVM) analysis.

8. The method of claim 6, wherein the outcome of the project comprises one of a success of the project and a failure of the project.
